(19) United States
(12) Patent Application Publication
(10) Pub. No.: US 2025/0234854 A1
(43) Pub. Date: Jul. 24, 2025

(54) RODENT TRAP AND STREET FURNITURE COMPRISING SUCH A TRAP

(71) Applicant: SECU-RAT, Besançon (FR)

(72) Inventors: Julien HOFFMANN, Selestat (FR); Philippe RIEHLING, La Wantzenau (FR); Mickaël SAGE, Besançon (FR); Vincent SCHALLER, Strasbourg (FR)

(73) Assignee: SECU-RAT, Besançon (FR)

(21) Appl. No.: 18/703,513

(22) PCT Filed: Oct. 6, 2022
(86) PCT No.: PCT/EP2022/077793

§ 371 Date: Apr. 22, 2024

(30) Foreign Application Priority Data
Oct. 28, 2021 (EP) 21306508.9

(51) Int. Cl. A01M 23/16; A01M 25/00; A01M 99/00; B65F 1/14

(52) U.S. Cl. CPC A01M 23/16; A01M 25/004; A01M 99/00; B65F 1/14

(57) ABSTRACT

A rodent trap includes an internal rodent baiting and/or elimination device which is removable, a base for a street furniture, separate from the device, and a device for reversible attachment of the trap to the street furniture. The removable internal device includes a support and one or more lateral walls delimiting an interior space and forming one or more accesses. The base includes a body including one or more lateral walls, forming a lower opening and delimiting an internal space for removably receiving the internal device. The wall or walls include one or more arched entrance openings, arranged in an offset manner relative to the access or accesses to the interior space to form a zig-zag path from the outside of the internal space of the base to the inside of the interior space of the internal device. Also, a rodent trap assembly and street furniture including such a trap.

### OBJECT OF THE INVENTION

The present invention relates to a rodent trap, such as for rats, mice, field mice or voles, and to an urban device, preferably a garbage collection device, comprising one or more such rodent traps.

### STATE OF THE ART

Rats, like mice, field mice or voles, are among the rodents the proliferation of which causes serious disorders, including environmental degradation, and constitutes a threat to public health, particularly as a result of their droppings and urine.

Rodents are generally attracted by foodstuffs stored by man and organic waste generated by man.

Particularly when it comes to the collection and storage of garbage, indoor and outdoor garbage collection devices, domestic garbage cans, household garbage collection bins or skips and outdoor garbage cans are all collection points which attract numerous rodents and therefore constitute crucial points for their regulation.

Garbage cans generally comprise a rubbish receptacle in the form of a mesh or perforated tray, through which rodents crawl to tear open the flexible bag, which is installed there, containing the garbage.

One solution is to prevent rodents from gaining physical access to the inside of the garbage can. In this case, the receptacle comprises solid walls, closed off by a lid, preferably self-closing, as with a dumpster. However, this may not be sufficient, as the rodent will always find a way into the garbage can. Furthermore, in addition to being unsightly, such garbage cans present the disadvantage of not allowing visual control of the contents of the bag receiving the garbage, which is generally transparent for public safety reasons.

Another solution is to place bait boxes, mechanical traps or chemical bait in the vicinity of garbage cans. These are generally boxes containing a toxic substance, a poison, a rodenticide product, as for example an anti-coagulant, or even a bait placed within, or close to, a mechanical lethal device, for example, of the fag type, electrical, by drowning or asphyxiation using an inert gas.

For example, document US2013174471 describes a bait box comprising a base, equipped with lateral walls and closed by a lid, adopting the shape of a curved channel forming one or more bends.

For bait boxes, it is also known, as described in document KR20080109307, to equip them with a camera in order to collect images of pests having entered the box.

Although such bait boxes are easily transportable and are therefore easily placed and moved to different locations, they can be inadvertently moved or turned upside down, and therefore be less effective, or vandalized and therefore rendered inoperative. They are, furthermore, unsightly, obtrusive and accessible to non-targeted species, as for example wild animals, domestic pets or children.

To block the view of the inside of the trap, to limit the size of the animal that can enter and to prevent children or domestic pets from gaining access, U.S. Pat. No. 6,145,242 describes a trap comprising a cover, looking like a rock, comprising access openings to the inside of the trap, which fits over a base plate arranged on the ground, on, at the center of, and from which extends a bait station provided with access to the center of the bait station, the bottom plate comprising vertical panels, projecting upward from the bottom plate, which are positioned behind the lid apertures to block the view of the inside of the trap and to limit the size of animals able to access the trap.

There are also rodent traps integrated into garbage collection devices, and forming an integral part of the garbage can body, as described for example in U.S. Pat. No. 2,501,282.

There are also garbage cans with removable rodent traps.

For example, document WO2020057709 describes a rodent trap having a closed bait chamber, taking the form of a drawer which engages, in a horizontal movement in translation, in a receiving part which partially closes the trap and forms the outer part of a garbage can, an integration frame closing the bait chamber in the receiving part. The integration frame comprises trap access holes which are aligned with the holes in the bait chamber.

Such traps present the disadvantage of allowing the bait to be too easily accessible to birds, a child or to a person who is not a pest controller, and they present the additional disadvantage of being difficult to install or replace. Moreover, in the case of such traps, the openings form obstacles that rodents have to overcome in order to enter, which reduces their effectiveness.

To prevent children or domestic pets from gaining access to the interior of a trap reversibly attached to a garbage can, document U.S. Pat. No. 3,488,879 describes a one-piece base for a garbage can, formed in one piece, which is an inverted cup, comprising an annular peripheral flange, forming a raised portion, intended to receive the bottom of the garbage can and comprising holes made in the outer wall of the flange to allow access to the trap. The flange forms a central recessed portion, closed off by an upper plate to form an internal housing, intended to receive the bait, which is accessible thanks to an interior hole, made in the inner wall of the flange, which is not connected, not in line with the outer lateral openings of the flange.

Such a trap presents the disadvantage of not being easy to handle for maintenance purposes, and to be of perfectible effectiveness, here again, the access holes form obstacles that rodents have to overcome in order to enter.

### Aims of the Invention

The present invention aims to provide a rodent trap and a piece of street furniture, for example a garbage collection device, which do not present the disadvantages of the state of the art.

The present invention aims to provide an alternative to existing prior art solutions.

The present invention aims to provide a rodent trap, and a rodent trap assembly, which are easy to use and handle, during installation of the trap in street furniture and/or when coupled to street furniture, in particular to a garbage collection device.

The present invention aims to provide a rodent trap which can be installed as close as possible to sensitive areas or areas where rodents live or feed.

The present invention aims to provide a rodent trap which is discreet, of improved effectiveness, and which presents protection for non-target animal species, the trap operator and children.

The present invention aims to provide a rodent trap that is adaptable to street furniture, preferably adaptable to all indoor or outdoor garbage collection devices, in particular outdoor garbage cans.

### SUMMARY OF THE INVENTION

The present invention relates to a rodent trap comprising an internal rodent bait and/or elimination device which is removable, a base for a street furniture, which is separate from the internal device, and means for a reversible attachment of the trap to street furniture, the removable internal device comprising a support and one or more lateral walls delimiting an interior space and forming one or more accesses, the base comprising a body comprising one or more lateral walls forming a lower opening and delimiting a removable internal receiving space of the device, the wall or walls comprising one or more arched entrance openings, arranged in an offset manner relative to the access(es) to the internal space, to form a zig-zag path from the exterior of the internal space of the base toward the interior space of the internal device.

According to particular embodiments of the invention, the rodent trap according to the invention comprises at least one, or any suitable combination, of the following features:
the removable internal device comprises two accesses forming, relative to each other, a chicane
the support of the removable internal device comprises a beveled edge at each access to the interior space of the internal device,
the removable internal device comprises means for attaching the internal device to the base for reversible attachment,
the base comprises one or two more arched entrance openings than the access or accesses to the internal device,
the base further comprises a main opening, configured to allow placement of the internal device within the interior space of the base, the main opening being able to be closed, and in operation closed, by a movable and/or removable partition,
the rodent trap further comprises means for baiting and/or eliminating rodents,
the rodent trap further comprises means for preventing rodents from leaving the interior space of the internal device once they have entered it,
the rodent trap further comprises anchoring means for reversible attachment of the trap to the surface on which it is placed,
the anchoring means are, or comprise, one or more fixing lugs provided at the base, which extend substantially horizontally from the lower end of one of the base walls toward the internal space,
the means for reversible attachment of the trap to a street furniture comprises an intermediate attachment plate interposed between the body of the base and the street furniture, the plate being configured to cooperate and in operation cooperate with fastening means of the screw, rivet or equivalent type,
the rodent trap further comprises means for detecting the presence or entry and/or exit of rodents from the trap, and/or for triggering baiting and/or rodent elimination means and means for communicating with a remote third party.

The present invention also relates to a rodent trap assembly comprising an internal device for baiting and/or eliminating rodents which is removable and comprising a support and one or more lateral walls delimiting an interior space and forming one or more accesses, a base for a street furniture comprising a body comprising one or more lateral walls forming a lower opening and delimiting an interior space for removably receiving the internal device, the wall(s) comprising one or more arched entrance openings, and means for reversible attachment of the trap to a street furniture, the internal device and the base being configured to be associated in such a way that the arched entrance openings are arranged in an offset manner, relative to the access(es) to the interior space, to form a zig-zag path from the outside of the interior space of the base to the inside of the interior space of the internal device. It also relates to the use of one or more of these assemblies to equip street furniture with one or more rodent traps.

The present invention also relates to the use of one or more rodent trap assemblies according to the claim of the invention, to equip a street furniture with one or more rodent traps.

The present invention also relates to a street furniture comprising one or more rodent traps according to the invention, the street furniture preferably being a garbage collection device.

### BRIEF DESCRIPTION OF THE FIGURES

FIG. 1 is a schematic perspective view of a piece of a street furniture, in particular a garbage collection device, according to the invention.

FIG. 2 is a schematic perspective view of one embodiment of the rodent trap according to the invention, as such, not associated with a street furniture.

FIG. 3 is a schematic side view of the rodent trap, according to the invention, as such, not associated with a street furniture.

FIG. 4 is an exploded schematic perspective view of the embodiment of the rodent trap according to the invention shown in FIG. 2.

FIG. 5 is a schematic perspective view of one particular embodiment of the internal device of the rodent trap according to the invention.

FIG. 6 is a schematic top view of the internal device shown in FIG. 5.

FIG. 7 is an exploded schematic perspective view of one particular embodiment of the internal device shown in FIG. 5.

FIG. 8 is the same schematic, exploded, perspective view of the particular embodiment of the internal device as that shown in FIG. 7.

FIG. 9 is a schematic perspective view of one particular embodiment of the base of the rodent trap according to the invention.

FIG. 10 is a schematic view, according to another perspective, of the particular embodiment of the base shown in FIG. 9.

### DETAILED DESCRIPTION OF THE INVENTION

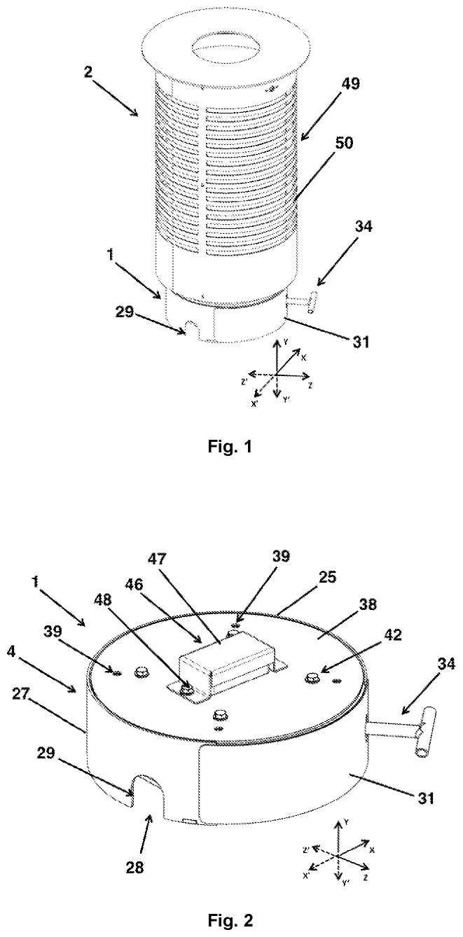

In the remainder of the description and the claims, the terms “under”, “underneath”, “on”, “above”, “upper”, “lower”, “vertical” or “horizontal” refer to the normal vertical position of use of the rodent trap 1 according to the invention and to the normal position of use of the elements constituting it, during normal use of said trap 1, and in particular as shown in FIGS. 1 to 10.

The term “ground” should be understood as being the upper surface of the earth, whether covered with vegetation or a stone or bituminous type covering, but it should also be understood as likely to be the bottom, or the floor, of a cavity or hole, whether masonry or not, made in the ground.

Without excluding the possibility of it being used as such, or being integrated into a piece of a street furniture, the rodent trap 1 according to the invention is a trap for street furniture. It is suitable for, and configured to, be coupled to any street furniture, advantageously to a garbage collection device 2. For this reason, and without limitation, in the remainder of the description, the trap 1 is described for interaction with a garbage collection device 2.

The rodent trap 1 according to the invention comprises an internal device 3 for rodents, which allows baiting and/or elimination of rodents. It can be used for, and allows monitoring of, the frequentation and duration of frequentation of the trap 1 by one or more rodents and/or to be used to eliminate them.

The internal device 3 is able to, and configured to, cooperate with, interact and/or being attached and/or being nested, with or in a street furniture support or base 4, which is a separate element from the internal device 3, and which is able, and configured to, interact and/or being attached and/or being nested with, from the side and/or under, a street furniture, preferably a garbage collection device 2 (FIG. 1).

The internal device 3 for rodents, is a removable device, which can nevertheless be reversibly associated with the base 4. It is preferably reusable.

Preferably, in operation, the internal device 3 comprises means for baiting and/or eliminating rodents.

The means for baiting and/or eliminating rodents comprise, or are, one or more baiting products, having the form of, for example, one or more blocks, pastes or cereals, which may comprise, be associated with, or cooperate with, rodent elimination products or devices, as for example, one or more toxic or lethal agents, poisons or rodenticides, for example, anti-coagulants, or sterilizing agents, for example, able to coat the baiting product, one or more mechanical or electrical devices, for example, one or more swatters, percussion traps, or equivalent, one or more sticky materials, or means capable of, and configured to, deliver one or more electrical shocks, preferably high voltage, or asphyxiation or drowning means.

The internal device 3 can be of one-piece or can be constituted of a number of separate elements assembled together (FIG. 7).

Whatever the embodiment, the internal device 3 comprises a horizontal support 5, from which extends, substantially perpendicularly toward the top, at least one wall 6, preferably two walls 6, 7, advantageously a multitude of walls 6, 7, known as lateral walls, which are preferably smooth. The internal device 3 is not a closed device in that it does not comprise an upper wall or cover.

The support 5 may have a smooth surface, which presents the advantage of being easy to clean. It may also comprise cavities, preferably in the area of the baiting and/or rodent removal means, in order to retain any bait debris that may have fallen onto the support 5 as a result of nibbling of the bait by the rodents, which presents the advantage that it is not dispersed outside the internal device 3.

The support 5 and the walls 6, 7 are substantially rigid, and do not bend under their own weight. Preferably, they have a thickness which is as thin as possible, of the order of 0.5 to 5 mm. They are made of, or comprise, a material, or assembly of materials, presenting a mechanical and chemical resistance, compatible with the presence of rodent baiting and/or elimination means and also the frequentation of the internal device 3 by the rodents. In particular, they are resistant to rodent feces and urine. Preferably, they are made of or comprise plastic material(s).

Preferably, the wall(s) 6, 7 are formed from a single piece having the desired shape, for example a folded metal plate, or a molded or injected plastic plate, but they may also comprise several separate pieces, suitably assembled together.

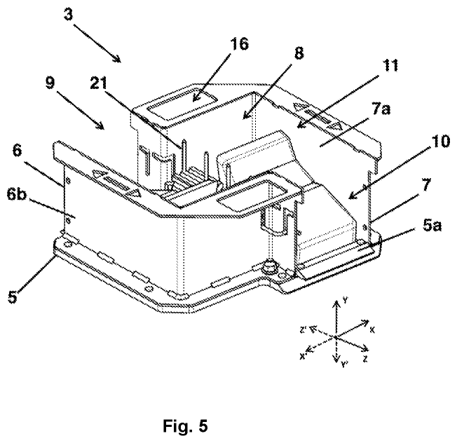

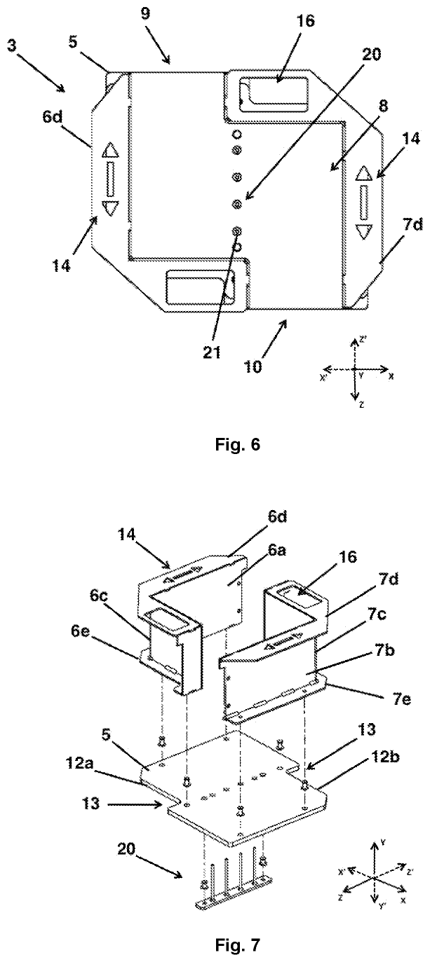

The wall(s) 6, 7 delimit an interior space 8. It comprises or they comprise an internal surface 6a, 7a, facing the interior space 8, and an external surface 6b, 7b, opposite the internal surface 6a, 7a and facing the space defined by the housing 26 of the base 4. The wall(s) 6, 7 define(s) at least one access 9 or 10 to the interior space 8, preferably two accesses 9 and 10, or a multitude of accesses 9, 10, preferably accesses 9, 10 which are lateral, and possibly also an upper opening 11 (FIGS. 5 to 6).

In contrast to the access holes in the walls 6, 7, in the internal device 3 according to the invention, it is the wall 6 or 7 or the walls 6 and 7, its or their arrangement with each other, and with the support 5, that forms or form the accesses 9, 10. This presents the advantage of providing wide openings toward the interior of the internal device 3 without forming, for rodents, obstacles that are difficult to cross or straddle.

In the embodiments in which the internal device 3 comprises at least two, preferably a multitude of accesses 9, 10, the latter are not arranged opposite each other, or the others, and are not aligned with each other or the others, but are arranged in an offset manner (FIG. 6). This presents the advantage of forming at least one chicane.

Preferably, the baiting and/or elimination means are found arranged at the edge of these accesses 9, 10, or in their direct extension, or even in the center of the internal device 3.

By way of example, and as shown in FIGS. 4 to 8, the support 5 is substantially plane and flat, and extends in the plane X-Z. Preferably, it comprises at the bottom of access point(s) 9, 10, a beveled edge 5a acting as an access ramp. This presents the advantage of encouraging rodents to climb onto the support 5 and therefore into the internal device 3.

The wall or walls 6, 7 have at least one substantially vertical portion 6c, 7c, extending according to the axis Y-Y′ and in the plane Y-Z and/or the plane X-Y, and preferably substantially flat. Advantageously, they present an “L”- or “Z”-shaped cross-section in the plane X-Z, which allows the accesses 9, 10, to be formed, which are offset.

In this embodiment, the support 5 preferably comprises at least two edges 12a, 12b each comprising a step 13, the edges 12a, 12b thus having, in the plane X-Z, a substantially “Z”-shaped cross-section. Advantageously, a portion of the “L” or “Z”-shaped walls 6, 7 extends along a part of the “Z”-shaped edges 12a, 12b of the support 5, so that the accesses 9, 10 are offset in a more marked manner (FIG. 7).

Preferably, the vertical portion 6c, 7c of the wall(s) 6, 7 has a truncated edge at the level of the accesses 9, 10, or having a longitudinal section, in the plane Y-Z, in the shape of a “T”, which presents the advantage of obtaining wider access(es) 9, 10 thus favoring the arrival of rodents on the access(es) 9, 10.

Preferably, the wall or walls 6, 7 comprise at least one upper angle 6d, 7d, extending substantially perpendicular to and along, its or their vertical portion 6c, 7c, and preferably having a cross-section, in the plane X-Z, in the shape of an “L”-along the form of the section of the wall or walls 6, 7.

Preferably, the upper angle 6d, 7d comprises means 14 for indicating the direction of insertion of the internal device 3 into the housing 26 of the base 4, which presents the advantage of allowing correct positioning of the internal device 3 relative to the base 4.

Preferably, the upper angle 6d, 7d cooperates with the stop means 15 provided at the base 4, comprising or consisting of the angles 17.

Preferably, the internal device 3 comprises means 16 for attachment to the base 4, of the street furniture, for reversible attachment. These means 16 cooperate with, and preferably receive, complementary fastening means provided on the base 4. These may be one or more mortises, having, for example, the form of holes, slots or apertures, able to receive, and receiving in operation, one or more tenons, which may have the form of angles. Nevertheless, whatever the embodiment of the rodent trap 1 according to the invention, the internal device 3 is not attached to the lateral wall(s) 6, 7 of the base 4.

Preferably, the wall or walls 6, 7 also comprise at least one lower angle 6e, 7e, extending substantially perpendicular to, and along, its or their vertical portion 6c, 7c, and preferably having a cross-section, in the plane X-Z, in the form of “L” following the form of the cross-section of the wall or walls 6, 7.

Preferably, the corner of the upper angle 6d, 7d, the corner of the lower angle 6e, 7e and the corner of the support 5, which are opposite each other, are beveled, which presents the advantage of allowing the internal device 3 to be fitted more easily into the base 4.

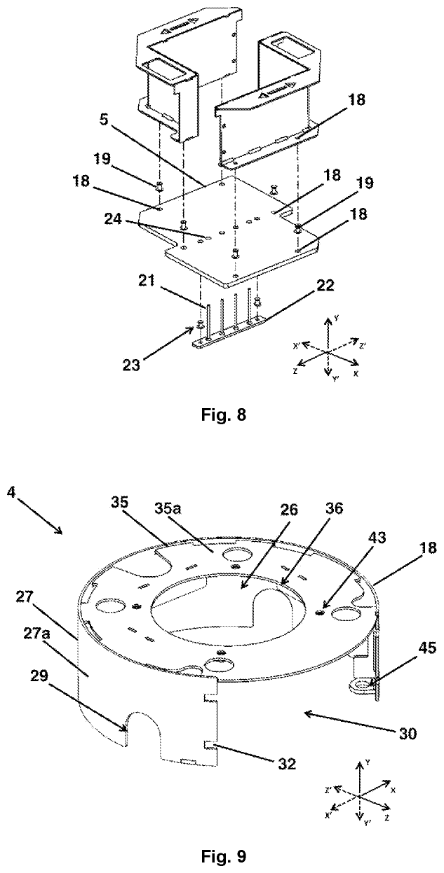

In the embodiments in which the internal device 3 is made of an assembly of elements (FIGS. 7 and 8), the wall or walls 6, 7 are attached to the support 5 by any suitable means, preferably by means for reversible attachment. This presents the advantage of making the internal device 3 removable or easily repairable.

In the embodiments in which a lower angle 6c, 7c is present, the wall(s) 6, 7 can be attached to the support 5 by its means (FIG. 7).

Preferably, the support 5, the wall or walls 6, 7, and possibly the lower angle 6c, 7c, if present, comprise receiving means 18, for example holes, able and intended to receive, and receiving, the assembly means 19 which comprise or are for example screws, bolts and nuts, or rivets.

The assembly means 19 can be tenons, advantageously engaging by force the receiving means 18, the holes, of the support 5. The tenons are made of or comprise a material or assembly of rigid materials, preferably elastic, and more malleable than the support material(s). They are forced into the holes and held in place by their resilience or elasticity.

Preferably, the assembly means 19 are, or comprise, blind rivets, comprising a rivet body and a pull rod with the breaking point of the pull rod being below the rivet head.

Preferably, the upper angle 6d, 7d, and possibly the lower angle 6c, 7c, are removably fixed to the wall(s) 6, 7, advantageously by means of tenons or tabs engaging, preferably by force, openings or recesses made on the upper edge, and the lower edge respectively, of the wall(s) 6, 7.

Preferably, the internal device 3 comprises support means 20 for baiting and/or eliminating rodents, which allow, for example, bait to be fixed in block or paste form, whether or not they comprise lethal agents. Advantageously, these support means 20 are also means forming a stop for the rodent elimination means, for example mechanical or electrical devices.

The support means 20 comprises, one or more horizontal rods (not shown in the figures) and/or vertical rods 21, extending substantially vertically according to the axis Y-Y′, from the support 5, into the interior space 8.

Preferably, the vertical rods 21 are arranged side by side, substantially in the center of the internal device 3, advantageously along a median, extending according to the axis Z-Z′ and separating the support 5 into two equal parts, as shown in FIGS. 5 and 6. This presents the advantage of being able to use the same internal device 3 whether you only want to bait, or bait and eliminate the rodents. Indeed, it is not necessary to remove them to install one or more mechanical or electrical elimination devices, these latter being able to be positioned on either side of the line formed by the vertical rods 21.

The vertical rods 21 are made of or comprise any suitable material or assembly of materials. Preferably, they are made of stainless steel.

Preferably, these vertical rods 21 are attached, by any suitable means, to a support plate 22, which is fixed under the support 5 of the internal device 3, by the assembly means 23, of the screw, bolt and nut, rivet or equivalent type, the vertical rods 21 engaging, and extending through, through-holes 24, made in the support 5 of the internal device 3 (FIG. 8). This presents the advantage of having the support means 20 that cannot be moved by rodents, which would disperse the bait and obstruct the rodent exit, while nevertheless allowing them to be replaced or maintained.

Preferably, the rodent trap 1, advantageously, the internal device 3, further comprises means preventing rodents from exiting the interior space 8 once they have entered it. These means are preferably located at the access point(s) 9, 10 of the internal device 3. Advantageously, these anti-escape means comprise, or are, one or more rocking trays, doors or non-return flaps, a net or stairs.

The internal device 3, and the elements of which it is composed, have dimensions that are suitable and compatible with the base 4 of the rodent trap 1, and with those of the street furniture, for example the garbage collection device 2 to which it is to be connected, and it is connected when in use.

The base 4 of the trap 1 according to the invention has dimensions and a shape which are adapted to and compatible with the internal device 3 and those of the street furniture, for example of the garbage collection device 2 to which, or element of the garbage collection device 2 to which, it is to be connected, and it is connected when in use.

The base 4 comprises a body 25, delimiting an internal space 26, intended to receive and receiving the internal device 3, and delimiting an external space which is the exterior of the trap 1.

The body 25 is, or comprises, at least one wall 27, possibly several walls 27, comprising an external surface 27a facing the exterior of the rodent trap 1, and an internal surface 27b facing the interior of the internal space 26. Preferably, the wall or walls 27 are lateral walls, substantially vertical.

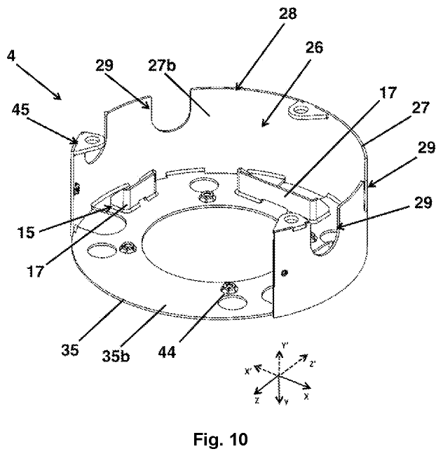

As shown in FIGS. 9 and 10, the base 4 is not a closed housing. The body 25 is not closed, and the internal space 26 is open. The base 4 is an open structure, the body 25 of which is open, when the base 4 is considered as such, as long as it is not fixed, connected, under the street furniture, for example the garbage collection device 2, or as long as it is not placed or fixed on the ground.

The base 4 is devoid of the bottom wall but comprises a lower opening 28. The wall(s) 27 of the body 25 delimit(s) and form(s) the lower opening 28, located at the bottom of the body 25, opening out at ground level. The lower opening 28 is intended to be closed, and, when in use, is closed, by the ground surface, when the body 25 is positioned on the ground, or when it is in place under the street furniture, in its normal position of use. It is the positioning of the base 4 on the ground that closes the internal space 26 of the base 4. This presents the advantage of providing rodents entering the trap 1 with surface continuity between the outside ground and the rodent trap 1, thus facilitating their entry and progress through the trap 1.

The base 4 comprises one or more arched entrance openings 29, cut into the wall(s) 27, allowing access to the internal space 26 of the base 4, and then to the trap 1. The opening(s) is (are) of a shape and dimension that is (are) suitable and compatible with rodents and preferably does not allow access to non-target species, such as domestic pets or children. The arched entrance opening(s) 29 may have the shape of an arch, preferably rounded, circular, elliptical, square, rectangular, triangular, hexagonal, polygonal or a combination thereof.

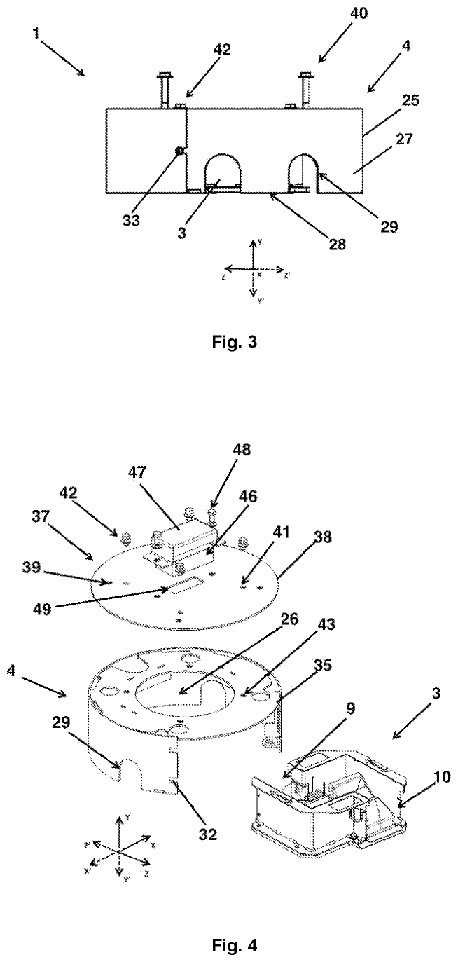

The entrance openings 29 are arranged so that it they are not facing, as a direct extension, of the access point(s) 9, 10 of the internal device 3, but are arranged offset, in order to form, between the internal surface 27b of the wall 27 of the base 4 and the external surface 6b, 7b of the wall(s) 6, 7 of the internal device 3, a path, which forms at least one or more zig-zags, or at least one chicane (FIGS. 2 and 3).

Preferably, the wall(s) 27 of the base 4 comprise as many entrance openings 29 as there are accesses 9, 10 of the internal device 3, advantageously, one or two entrance openings 29 more than the accesses 9, 10 of the internal device 3, in order to increase the circulation of rodents in the trap 1, and therefore improve its efficiency.

Preferably, the entrance opening(s) 29 is (are) arranged relative to the access 9 or 10 or the accesses 9, 10 in such a way that the path(s) between the exterior of the trap 1 and the internal device 3 is (are) the longest and/or most angular.

By way of example, for an access 9, 10 extending according to Z-Z′, an entrance opening 29 may extend according to the axis X-X′, the access 9, 10 and the entrance opening 29 preferably being arranged at approximately 90° to one another, or the access 9, 10 and the entrance opening 29 may extend according to the same axis, for example, the axis Z-Z′, the two being arranged, advantageously, opposite each other, at 180° to each other. In the case of the trap 1 shown in FIG. 4, the entrance openings 29 are located at approximately 90° to one or the other of the accesses 9, 10 of the internal device 3.

This presents the advantage of preventing all or part of the body of a non-target species from gaining access to the internal device 3 and therefore to the means of baiting and/or eliminating rodents. In addition, this allows to multiply the potential areas of friction against the external surface 6b, 7b of the wall(s) 6, 7 of the internal device 3 and/or the internal surface 27b of the wall(s) 27 of the body 25 of the base 4, thus promoting the detachment of all or part of the baiting and/or the elimination means which may have stuck to the body, the fur or legs of rodents having had access to the internal device 3, residues which are thus maintained in the trap 1, are not accessible to non-target animals, and are not dispersed into the environment.

Preferably, the body 25, or the wall(s) 27, of the base 4 may comprise a lateral main opening 30, of a larger dimension than that of the entrance openings 29, allowing access to the internal space 26, and in particular, allowing the internal device 3 to be positioned within the internal space 26, and possibly its attachment to the base 4.

This main opening 30 is closed by a partition 31, preferably movable or removable, and advantageously cooperating with the means for securing the partition 31 to the body 25, in order to form an inspection hatch for the internal space 26, allowing access to the internal device 3.

The partition 31 can be movable relative to the body 25, thanks for example to the hinged means, and/or removable by the use of engagement of a notch 32, made at one of the ends, preferably both ends, of the wall(s) 27 and/or partition 31, with a tenon 33, threaded or not, a bolt fitted with a nut, or equivalent, attached to the external surface of the wall(s) 27 and/or the partition 31.

Preferably, the partition 31 comprises or cooperates with means for maneuvering 34 the partition 31, for example a handle, or a key allowing the actuation of the means for locking and unlocking the partition 31 to the body 25, while preferably also allowing its maneuvering.

Preferably, the body 25 of the base 4 also comprises a substantially flat upper plate 35, with or without apertures, extending substantially horizontally in a plane substantially parallel to the plane X-Z, from which the wall or walls 27 extend substantially perpendicularly. The upper plate 35 comprises an upper surface 35a, intended to face the street furniture, for example the bottom of the garbage collection device 2, a lower surface 35b, opposite the upper surface 35a.

In this embodiment, the body 25 preferably has a cross-section, in the plane X-Y, substantially in the shape of an inverted “U”, or an inverted “C” (FIG. 9).

In the case of a street furniture, for example a garbage collection device 2 the body of which has a substantially circular lower base, the upper plate 35 of the base 4 has a shape, in the plane X-Z, which is substantially disc-shaped. The wall or walls 27, extending along the periphery of the upper plate 35, also possess a circular cross-section in the plane X-Z (FIG. 9).

Preferably, the upper plate 35 comprises a central opening 36 which presents the advantage of allowing vertical access to the internal space 26, and therefore also to the interior space 8 of the internal device 3.

The base 4 may be a single piece, but preferably it is constituted of several separate elements, assembled together, in particular the wall(s) 27 are fixed, by any suitable means to the upper plate 35.

The base 4 may further comprise the means 15 forming a stop for the internal device 3, which are, or comprise, angles 17, arranged on, and extending from, the lower surface 35b of the upper plate 35 of the body 25 of the base 4 toward the interior of the internal space 26 (FIG. 10).

According to the embodiments considered, the base 4 may comprise complementary attachment means cooperating with the means 16 for attaching the internal device 3 to the base 4. These may be, for example, one or more tenons, able to engage with, and which engage with, one or more mortises of the internal device 3, preferably provided at the level of the wall or walls 6, 7, preferably on the upper angle 6d, 7d if present.

The base 4 further comprises the attachment means 37 for reversible attachment of the base 4 to the garbage collection device 2, preferably at the base thereof, at the lower surface of the bottom thereof.

These attachment means 37 are or comprise an intermediate attachment plate 38, which is preferably removable, and/or the receiving means 39 of the through-hole type, tapped or not, possibly cooperating with nuts, which are provided respectively on the garbage collection device 2 or on the body 25 of the base 4 or its upper plate 35 (FIG. 4).

These attachment means 37 also comprise, or cooperate with, the complementary attachment means 40, such as screws, bolts and nuts, rivets, studs or equivalent. They may be independent elements or form part of the body 25 of the base 4, the upper plate 35, the intermediate fixing plate 38 and/or the garbage collection device 2.

Preferably, in the embodiments in which the intermediate fixing plate 38 is present, the latter may comprise the receiving means 41, for example through holes, tapped or not, different, distinct, from the receiving means 39 for attaching to the garbage collection device 2.

Preferably, the intermediate fixing plate 38 is attached to the body of the base 4, advantageously to its upper plate 35, by means of the complementary attachment means 42, of the screw, rivet, tenon or equivalent type, engaging the receiving means 41 the intermediate fixing plate 38 and the receiving means 43 of the upper plate 35, which preferably comprise or cooperate with the securing means 44, for example locknuts, provided on the lower surface 35b of the upper plate 35 (FIG. 10).

Preferably, the base 4, whether located alongside or beneath the street furniture, is not fixed to the ground. This allows street furniture that would be movable, for example by means of wheels or castors, to remain movable, even when it includes the trap 1 according to the invention.

Nevertheless, it may be advantageous for fixed street furniture to be fixed to the ground by means of the trap 1.

To this end, the base 4 preferably comprises anchoring means 45, for advantageously reversible attachment of the rodent trap 1 to the ground surface. These anchoring means 45 are provided on the body 25 of the base 4. Preferably, they comprise or are, advantageously, fastening feet or fastening tabs extending substantially horizontally from the lower end of the wall or walls 27 of the body 25, in the plane X-Z toward the interior space formed by the internal space 26, the feet or tabs preferably comprising an opening intended to receive, and receiving, the anchoring means which are, or comprise, for example, a stake, a screw or the equivalent.

The rodent trap 1 according to the invention may further comprise the means 46 for detecting, preferably also counting and processing, the entry of rodents into the trap 1, and/or their exit and/or the triggering of mechanical, electrical, asphyxiation or drowning devices of the rodent elimination means. These means 46, present the advantage that they enable monitoring of the population of rodents frequenting the trap 1, or present in the trap 1 at a given moment.

Preferably, these means 46 are software and hardware means. They comprise one or more sensors for detecting the presence, passage and/or movement of rodents in all or part of the rodent trap 1, either at the level of the entrance opening(s) 29 of the base 4, and/or on the path between the wall(s) 27 and the access(es) 9, 10 of the internal device 3, and/or at the level of the access(es) 9, 10, and/or at the level of the interior space 8 of the internal device 3, and/or at the level of the baiting and/or rodent elimination means.

Preferably, these detection means 46 comprise or cooperate with the means for storing and/or processing the information collected by the sensor(s). They may comprise or cooperate with the communication means, via a communication network, preferably communication means, preferably wireless, for communication with a remote third party, to indicate, preferably in real time, whether and/or how many rodents are occupying or have occupied the trap 1 and the duration of occupancy.

Preferably, these means 46 are provided on the upper plate 35 of the base 4, or on the intermediate fixing plate 38 if present, and are, advantageously, secured by a protective plate 47 fixed by means of the fixing means 48, of the screw type or equivalent (FIGS. 2 and 4).

Preferably, the detection means 46, at least the rodent presence sensors, are provided above an opening 49 made in the intermediate fixing plate 38, which is found with respect to, and above, the central opening 36 of the base 4, which is found with respect to, and above, the interior space 8 of the internal device 3.

The rodent trap assembly according to the invention is a kit, a set of elements not associated with each other, in the form of distinct elements, not linked to each other, but able to be associated, arranged, with each other, in a reversible manner, when using the kit.

The kit comprises the internal device 3 for rodents, possibly means for baiting and/or eliminating rodents, the base 4 for street furniture, possibly the means 37 for reversible fixing of said trap 1 to street furniture, for example the intermediate fixing plate 38, preferably also the complementary attachment means 40, of the type screws, bolts and nuts, rivets, tenons, or equivalent, for fixing the trap 1 to street furniture, and advantageously also the complementary attachment means 42, of the type screws, rivets, tenons, or equivalent, for fixing the intermediate fixing plate 38 to the base 4, as described above.

The street furniture according to the invention comprises one or more rodent traps 1 according to the invention, arranged on, under, in, beside, or integrated into the street furniture.

The street furniture is, or comprises, any furniture or furniture element, whether indoor or outdoor, whether it be rest furniture, such as for example a bench, a bench seat, a table, a booth, city cleaning furniture, such as a garbage can or a household refuse bin, public lighting equipment, information and communication equipment, such as a poster holder, a Morris column, a decorative object, such as a flower pot, an object useful for vehicular traffic, such as a barrier, bollard or parking meter, or gardening equipment, such as a composter.

The street furniture can be movable, for example by using displacement means such as wheels or castors, or stationery, fixed to the ground, preferably by means of the rodent trap 1 according to the invention.

Preferably, the street furniture is a garbage collection device 2, advantageously an outdoor device, even more advantageously an outdoor litter garbage can or a household refuse collection bin.

The garbage collection device 2 presents the advantage of being attractive to rodents, as it comprises organic matter, which is palatable and may constitute their food. It integrates perfectly into the urban environment and can be located as close as possible to rodent habitats.

The garbage collection device 2 according to the invention preferably comprises a body 49, arranged vertically, according to the axis Y-Y′, which is hollow. In normal use, it may comprise one or more detachable, replaceable garbage receiving devices extending into the body 49, for example one or more flexible, disposable bags, so-called “trash bags”, or one or more plastic or metal bins.

The body 49 comprises rigid, solid and/or perforated walls 50 defining an interior space for receiving garbage or receiving and deploying all or part of a disposable bag, this space being delimited by at least one bottom wall.

The rodent trap(s) 1 according to the invention can be arranged, optionally fixed, preferably reversibly, inside the body 49 of the garbage collection device 2, against one or more of these walls 50 and/or on the bottom wall, or even outside the body 49, against one or more of these walls 50, or, as shown in FIG. 1, under its bottom wall.

If the garbage collection device 2 is an outdoor garbage can, it may comprise means for supporting the garbage receiving device(s), and optionally movable means for closing the interior space of the body 49.

The rodent trap 1 according to the invention can be associated with street furniture, for example with a garbage collection device 2, before the latter is placed at its location in the public space. The base 4 is attached, possibly, by means of the intermediate attachment plate 38, to, beside or underneath the bottom wall of the street furniture, while the internal device 3 may already be present in the internal space 26, attached to the base 4, or may be attached after the base 4/street furniture assembly has been installed. If the street furniture is stationary, not movable, the assembly is then fixed to the ground, preferably by means of the base 4.

1. Rodent trap comprising an internal rodent baiting and/or elimination device which is removable, a base for a street furniture, which is separate from the internal device, and means for reversible attachment of the trap to the street furniture, the removable internal device comprising a support and one or more lateral walls delimiting an interior space and forming one or more accesses, the base comprising a body comprising one or more lateral walls, forming a lower opening and delimiting an internal space for removably receiving the internal device, the wall or walls comprising one or more arched entrance openings, arranged in an offset manner relative to the access or accesses to the interior space to form a zig-zag path from the outside of the internal space of the base to the inside of the interior space of the internal device.

2. The rodent trap according to claim 1, wherein the removable internal device comprises two accesses forming, relative to each other, a chicane.

3. The rodent trap according to claim 1, wherein the support of the removable internal device comprises a beveled edge at the level of each access to the interior space of the internal device.

4. The rodent trap according to claim 1, wherein the removable internal device comprises means for attaching the internal device to the base for reversible attachment.

5. The rodent trap according to claim 1, wherein the base comprises one or two more arched entrance openings than the access or accesses of the internal device.

6. The rodent trap according to claim 1, wherein the base further comprises a main opening, configured to allow the internal device to be positioned within the internal space of said the base, the main opening being able to be closed, and in operation closed, by a movable and/or removable partition.

7. The rodent trap according to claim 1, further comprising means for baiting and/or eliminating rodents.

8. The rodent trap according to claim 1, further comprising means preventing rodents from exiting the interior space of the internal device, once they have entered it.

9. The rodent trap according to claim 1, further comprising anchoring means for reversible attachment of the trap to the surface on which it is placed.

10. The rodent trap according to claim 9, wherein the anchoring means are, or comprise, one or more fixing feet provided at the base, which extend substantially horizontally from the lower end of the wall or walls of the base toward the internal space.

11. The rodent trap according to claim 1, wherein the means for reversible attachment of the trap to a street furniture comprises an intermediate fixing plate interposed between the body of the base and the street furniture, the plate being configured to cooperate and in operation cooperating with the attachment means of the screw, rivet or equivalent type.

12. The rodent trap according to claim 1, further comprising means for detecting the presence or entry and/or exit of rodents from the trap, and/or for triggering baiting and/or rodent elimination means and means for communication with a remote third party.

13. Rodent trap assembly comprising an internal rodent baiting and/or elimination device which is removable and comprises a support and one or more lateral walls delimiting an interior space and forming one or more accesses, a base for a street furniture comprising a body comprising one or more lateral walls forming a lower opening and delimiting an internal space for removably receiving the internal device, the wall or walls comprising one or more arched entrance openings, and means for reversible attachment of the trap to a street furniture, the internal device and the base being configured to be associated in such a way that the arched entrance opening or openings are arranged, in an offset manner, relative to the access(es) to the interior space, to form a zig-zag path from the outside of the internal space of the base toward the inside of the interior space of the internal device.

14. A method comprising equipping a street furniture with one or more rodent traps having one or more rodent trap assemblies according to claim 13.

15. Street furniture comprising one or more rodent traps according to claim 1.

16. The street furniture according to claim 15, being a garbage collection device.
